(19) United States
(12) Patent Application Publication
(10) Pub. No.: US 2009/0213121 A1
(43) Pub. Date: Aug. 27, 2009

(54) IMAGE PROCESSING METHOD AND APPARATUS

(75) Inventors: Dong-Yeol LEE, Suwon-si (KR); Sang-Gyoo SIM, Seoul (KR)

Correspondence Address: MCNEELY BODENDORF LLP, P.O. BOX 34175, WASHINGTON, DC, 20043, US

(73) Assignee: Samsung Electronics Co., Ltd., Suwon-si (KR)

(21) Appl. No.: 12/349,057

(22) Filed: Jan. 6, 2009

(30) Foreign Application Priority Data
Feb. 26, 2008 (KR) 2008-17496

(51) Int. Cl. G06T 15/20; G06F 3/048

(52) U.S. Cl. 345/427; 715/764

(57) ABSTRACT

An image processing method and apparatus. The image processing method includes an analysis module analyzing vanishing points of an image and icons by using a database, a mesh mapping module mapping a mesh on the image based on the result of analysis, and an icon mapping module mapping icons on the image based on the result of analysis. The mesh includes a plurality of horizontal lines and a plurality of perspective lines, and the icons include general icons indicating objects in the image and length icons indicating lengths.

### CROSS-REFERENCE TO RELATED APPLICATION

This application claims the benefit of Korean Patent Application No. 2008-17496, filed in the Korean Intellectual Property Office on Feb. 26, 2008, the disclosure of which is incorporated herein by reference.

### BACKGROUND OF THE INVENTION

1. Field of the Invention

Aspects of the present invention relate to an image processing method and apparatus, and more particularly, to an image processing method and apparatus, which can make an animation background image from a two-dimensional (2D) image.

2. Description of the Related Art

Recently, as user generated content (UCC) is becoming popular, an ordinary person can directly produce a moving image. However, it is not easy to produce a moving image with animation. Although a user can produce a moving image using a script-based UCC image production tool, it is difficult for the user to use a background desired by the user. In addition, when indicating a user's position or a moving path using a global positioning system and a map image, it is difficult to create animation using a 2D image.

There are two methods of making animation by synthesizing a 2D picture/photograph and a three-dimensional (3D) object. One is a method of making and using a 3D image from a 2D image, and another is a method of using a 2D image as a background.

Research on a method of making a 3D image from a 2D image has been conducted in the image-based rendering field. For example, there has been an attempt to make a 3D image using several sheet images and depth information of objects in the images. According to this method, when the view point of a camera is changed, an image at a different viewpoint can be made in short time. As another example, research for making animation using a sheet image has been conducted. A TIP (Tour Into the Picture) technique is a technique of making 3D expedition animation from a 2D picture/photograph, in which objects of a background are fixed, and new scenes are made in accordance with the change of a viewpoint occurring as a camera moves.

According to the method of using a 2D image as a background, when the position of a vanishing point is determined and the size of an object is defined, a perspective representation is applied to the object based on the movement of the object. In the method of making animation using the 2D image, a method of making a 3D image using several sheet images and depth information of objects in the images can promptly make the image based on the viewpoint of the camera, but it is not easy for a general user to generate the 3D image to match the several background images. Also, it is difficult to apply the TIP technique to an image having two or more vanishing points or an image having a vanishing point that is not revealed well. Although it is good to make the 3D image from the 2D image and to use the 3D image as the animation background, it is difficult to make some background images. In an environment where fewer resources are used, such as a mobile environment, it is difficult to perform a complicated operation.

According to the method of using the 2D image as a background, it is difficult to adjust the size of an object in accordance with perspective in an image and to measure the size of an actual thing and the size of an object in the image. In addition, if there is a building or a wall that the object in the image cannot approach, it becomes difficult to define a moving space, and two or more vanishing points may exist in the image.

### SUMMARY OF THE INVENTION

Aspects of the present invention provide an image processing method and apparatus, which can make an animation background image from a two-dimensional (2D) image without any complicated operation process.

Additional aspects of the present invention provide an image processing method and apparatus, which facilitates measuring of the size of an actual feature and the size of an object in an image.

According to aspects of the present invention an image processing apparatus is provided. The apparatus includes an analysis module to analyze vanishing points of an image and icons using a database; a mesh mapping module to map a mesh on the image based on the result of the analysis; and an icon mapping module to map icons on the image based on the result of the analysis; wherein the mesh includes a plurality of horizontal lines and a plurality of perspective lines, and the icons include general icons indicating objects in the image and length icons indicating lengths.

According to another aspect of the present invention, an image processing method is provided. The method includes analyzing vanishing points of an image and icons by using a database; mapping a mesh on the image based on the result of the analysis; and mapping icons on the image based on the result of the analysis; wherein the mesh includes a plurality of horizontal lines and a plurality of perspective lines, and the icons include general icons indicating objects in the image and length icons indicating lengths.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating the construction of an image processing apparatus according to an embodiment of the present invention;

FIG. 2 is a view illustrating an image on which a mesh is mapped in an image processing apparatus according to an embodiment of the present invention;

FIG. 3 is a view illustrating an image on which icons are mapped in an image processing apparatus according to an embodiment of the present invention;

FIG. 4 is a view explaining mesh correction in an image processing apparatus according to an embodiment of the present invention;

FIG. 5 is a view explaining correction of a single perspective line in an image processing apparatus according to an embodiment of the present invention;

FIG. 6 is a view explaining correction of a plurality of perspective lines in an image processing apparatus according to an embodiment of the present invention;

FIG. 7 is a view explaining correction of a plurality of perspective lines in an image processing apparatus according to an embodiment of the present invention; and

FIG. 8 is a flowchart illustrating an image processing process according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention will be described herein with reference to the accompanying drawings illustrating block diagrams and flowcharts explaining a method and apparatus to process an image. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, implement the operations specified in the flowchart block or blocks.

These computer program instructions may also be stored in a computer usable or computer-readable memory that can direct a computer or other programmable data processing apparatus to operate in a particular manner, such that the instructions stored in the computer usable or computer-readable memory produce an article of manufacture including instructions to implement the operations specified in the flowchart block or blocks.

The computer program instructions may also be loaded onto a computer or other programmable data processing apparatus to cause a series of operations to be performed on the computer or other programmable apparatus to produce a computer implemented process such that the instructions that execute on the computer or other programmable apparatus provide implement the operations specified in the flowchart block or blocks.

Also, each block of the flowchart illustrations may represent a module, segment, or portion of code, which comprises one or more executable instructions to implement the specified logical operation(s). It should also be noted that in some alternative implementations, the operations noted in the blocks may occur out of order. For example, two blocks shown in succession may in fact be executed substantially concurrently or the blocks may sometimes be executed in reverse order, depending upon the functionality involved.

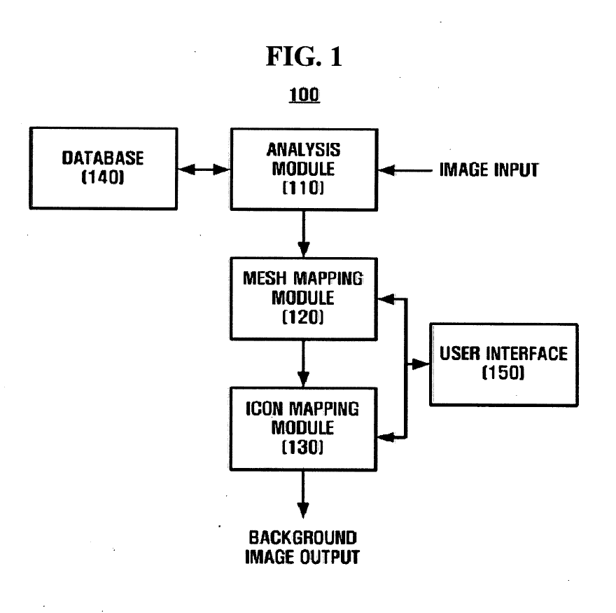

FIG. 1 shows an image processing apparatus 100 according to an embodiment of the present invention. As shown in FIG. 1, the image processing apparatus includes an analysis module 110, a mesh mapping module 120, an icon mapping module 130, a database 140, and a user interface 150.

The analysis module 110 analyzes an image using the database 140. Images in the database 140 are classified by features, subjects, time, and positions. The analysis module 110 searches for a similar image previously analyzed in the database 140. The analysis module 110 determines a vanishing point based on a similar image searched in the database 140, and analyzes an area where no object can be positioned as well as icons in the image.

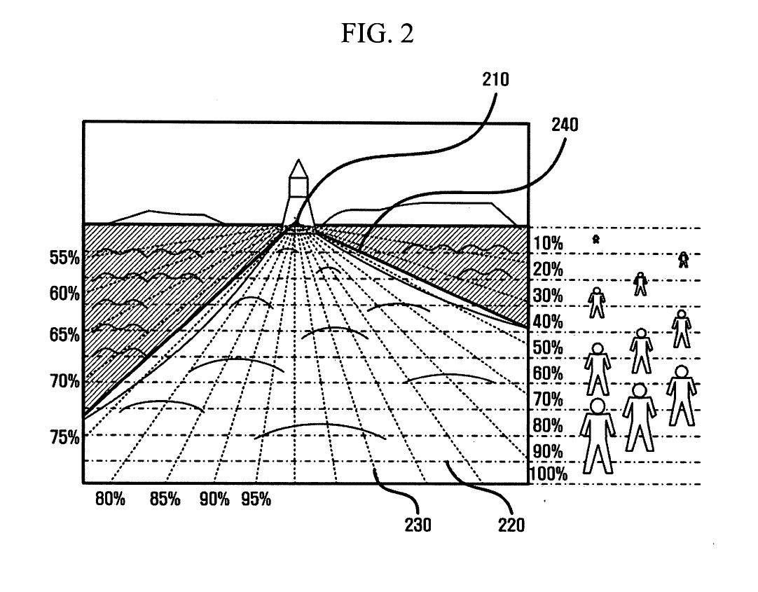

The mesh mapping module 120 maps a mesh on the image based on the vanishing point determined by the analysis module 110. The mesh includes a plurality of horizontal lines and a plurality of perspective lines. The mesh mapping module 120 generates the horizontal lines by dividing an area set from the vanishing point to the lowermost part into 10 equal parts. The mesh mapping module 120 generates 20 perspective lines around the vanishing point. The mesh mapping module 120 may indicate an area where no object can be positioned in the image as inhibition lines. The detailed description thereof will be made later with reference to FIG. 2. Although FIG. 2 shows 10 horizontal lines and 20 vertical lines, the mesh mapping module may divide the area into any number of parts, and may generate any number of perspective lines around the vanishing point

The mesh mapping module 120 maps two or more meshes on the image based on the number of vanishing points. The mesh mapping module 120 may provides the user interface 150 so that a user can correct the mapped mesh. The mesh mapping module 120 provides the user interface 150 capable of moving the whole mesh to accurately match the vanish point, adjust the size of the image or the mesh, or rotate the image or the mesh.

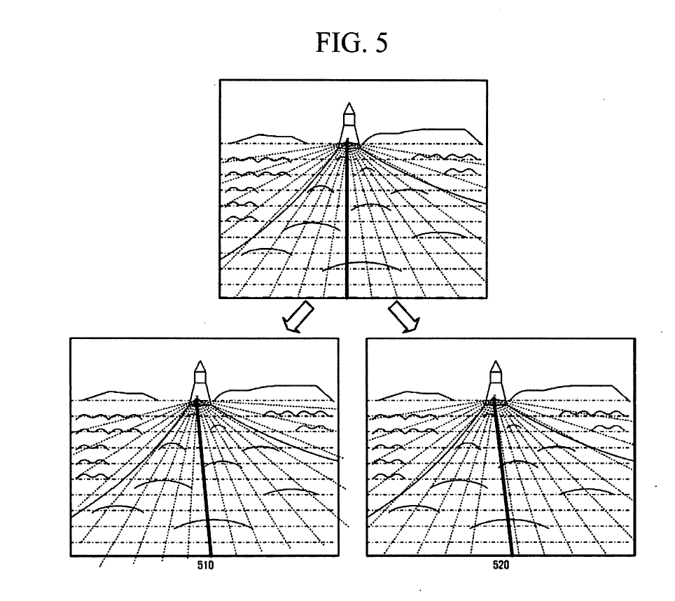

The mesh mapping module 120 provides the user interface 150 capable of moving the horizontal lines and the perspective lines. During the movement of the horizontal lines, the respective lines are moved so that they are leveled with one another. During the movement of the perspective lines, the perspective lines are moved such that the portions of the perspective lines where the perspective lines meet the vanish point are fixed. The mesh mapping module 120 provides the user interface capable of moving only one horizontal line or one perspective line, or moving the plurality of lines as a group. The detailed description thereof will be made later with reference to FIGS. 5 to 7. The user interface 150 may be provided to the user via a display (not shown)

The icon mapping module 130 maps icons on the image. The icons are predefined based on objects of which the sizes are generally determined, and are analyzed by the analysis module 110 using the database 140. The icons are divided into general icons indicating general objects (e.g., human beings, cars, chairs, street trees, and the like) and length icons indicating lengths (e.g., a width of a traffic lane, a width of a railroad, a length of a street lamp, and the like). The icon may be a standard capable of measuring the size of an object based on the position of the mesh. The icon mapping module 130 may provide the user interface 150 so that the user can correct the mapped icons. The icon mapping module 130 provides the user interface 150 capable of rotating, reducing, and enlarging the icons. As discussed above, the user interface 150 may be provided to the user via the display (not shown).

A background image completed through the processes of the respective modules can be animated based on the purpose of use. The completed background image is stored in the database 140, so that the completed background image can be utilized during future analyses.

The term “module”, as used herein, indicates, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

FIG. 2 shows an image on which a mesh is mapped in the image processing apparatus 100, according to an embodiment of the present invention. The mesh includes a vanishing point 210, a plurality of horizontal lines 220, a plurality of perspective lines 230, and one or more inhibition lines 240.

As shown in FIG. 2, 10 horizontal lines 220 are generated around and below the vanishing point 210. If the size of an object existing on the lowermost line is 100%, the size of the object becomes smaller by 10% to match the width between the lines. However, in order to prevent the object from becoming too small to be captured, the object should not be reduced below 10% in most cases. Also, it is assumed that no object can exist above the vanishing point 210; if an object does exist above the vanishing point, the object need not be affected by the mesh.

As shown in FIG. 2, 20 perspective lines 230 are generated around the vanishing point 210. Even if objects exist on the same horizontal line 220, these objects should be smaller as they are moved left or right from a visual point, and thus the size of the object is determined based on the perspective lines. Also, since an abruptly receding part may exist even on the same line, it is not necessary that intervals among the perspective lines 230 be equal.

In the case where an object in the image is moved, a space where the object cannot be moved due to a fence, a building, or the like, may exist, and such a space may be indicated as the inhibition line 240. In addition, a space where movement itself is prohibited may be indicated as the inhibition line.

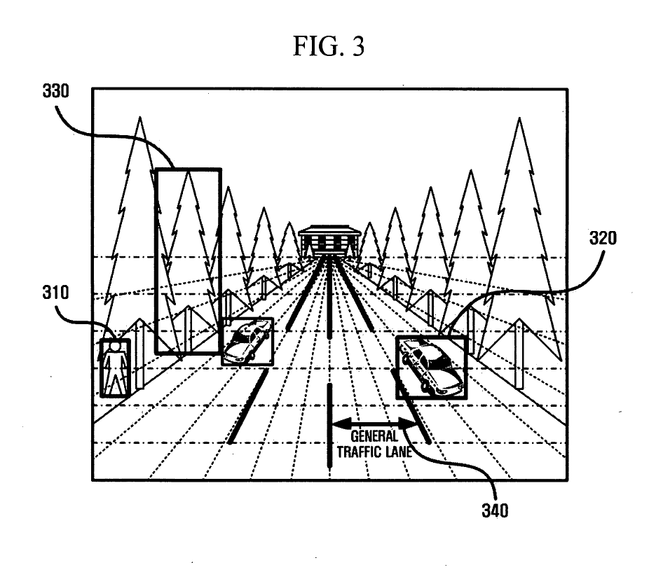

FIG. 3 shows an image on which icons are mapped in the image processing apparatus 100, according to an embodiment of the present invention. The icons may be the standard capable of measuring the size of objects based on their positions. Information on the icons is analyzed by the analysis module 110 through the database 140. The icons are divided into general icons indicating general objects, such as icons of human beings 310, cars 320, street trees 330, and the like, and length icons indicating lengths, such as icons of traffic lanes 340 and so on.

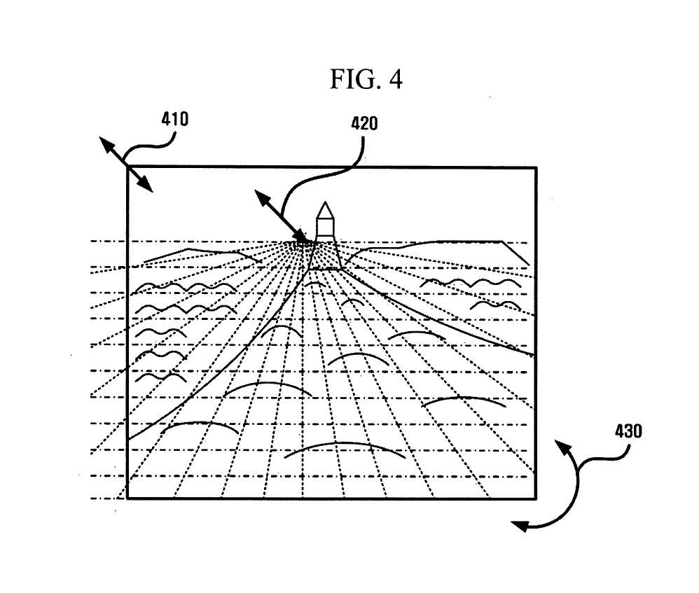

FIG. 4 shows mesh correction in the image processing apparatus 100, according to an embodiment of the present invention. The user interface 150 is provided so that the user can correct the mapped mesh. Through the user interface 150, the user can enlarge or reduce the image 410, move the vanishing point 420, or rotate the mesh 430. In addition, the user can enlarge or reduce the mesh, or rotate or move the image.

FIG. 5 shows correction of a single perspective line in the image processing apparatus 100, according to an embodiment of the present invention. Through the user interface 150, the user can select and move lines included in the mesh. When the selected line is optionally moved, the remaining lines may be moved in proportion to intervals among the lines 510, or may be in a fixed state 520.

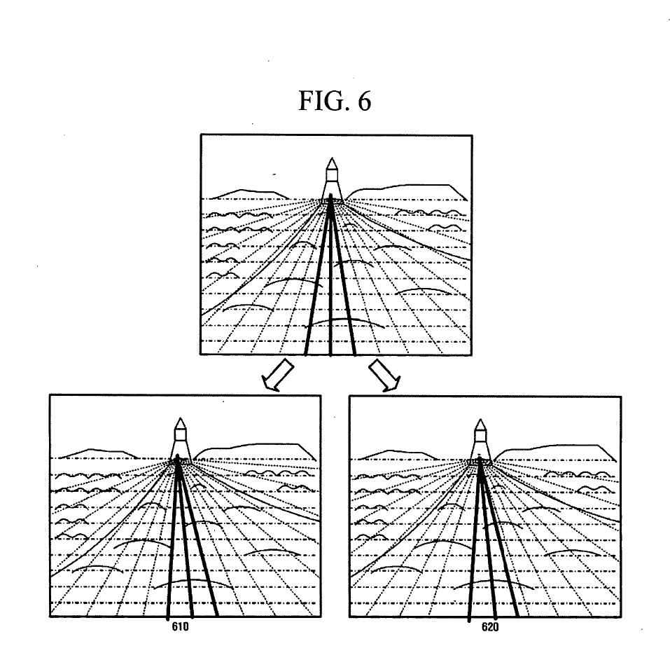

FIG. 6 shows correction of a plurality of perspective lines in the image processing apparatus 100, according to an embodiment of the present invention. Through the user interface 150, the user can move grouped lines among the lines included in the mesh. When the grouped lines are moved, the remaining lines may be moved in proportion to intervals among the lines 610, or may be in a fixed state 620.

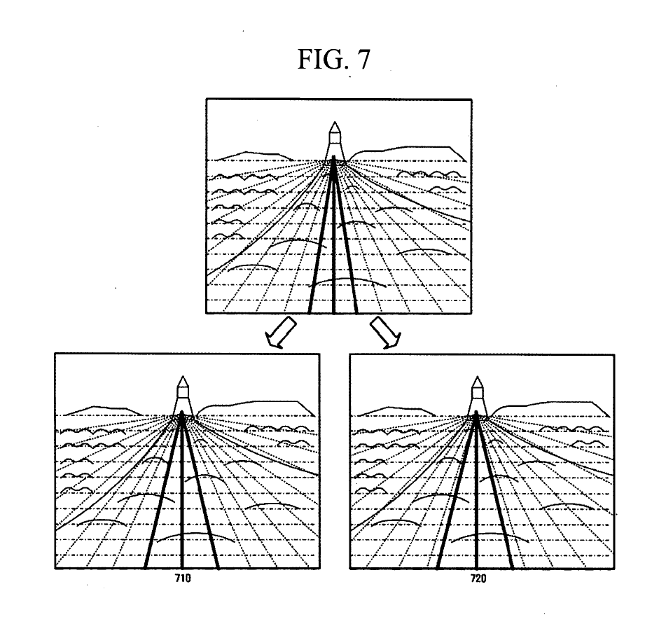

FIG. 7 shows correction of a plurality of perspective lines in the image processing apparatus 100, according to an embodiment of the present invention. Through the user interface 150, the user can adjust intervals among the grouped lines included in the mesh. When the intervals among the grouped lines are adjusted, the intervals among the remaining lines may be adjusted in proportion to the intervals among the remaining lines 710, or the remaining lines are in a fixed state 720.

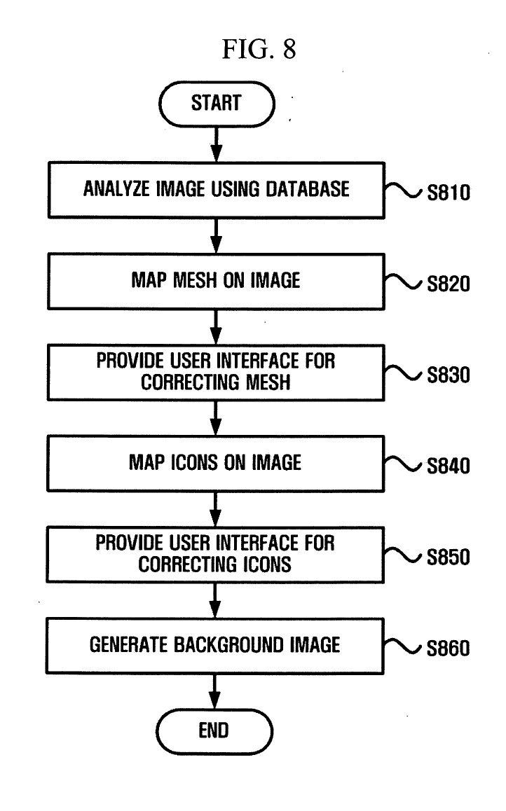

FIG. 8 is a flowchart of an image processing process according to an embodiment of the present invention. If an image is inputted, the image is analyzed by using the database 140 in operation S810. Images in the database are classified by features, subjects, time, and positions. The analysis module 110 searches for a similar image previously analyzed in the database 140. The analysis module 110 determines a vanishing point based on the similar image searched in the database, and analyzes an area where no object can be positioned and icons in the image.

A mesh is mapped on the image based on the vanishing point determined by the analysis module 110 S820. The mesh includes a plurality of horizontal lines and a plurality of perspective lines. The mesh mapping module 120 generates the horizontal lines by dividing an area set from the vanishing point to the lowermost part into 10 equal parts, and generates 20 perspective lines around the vanishing point. The mesh mapping module 120 may indicate an area where no object can be positioned in the image as inhibition lines.

A user interface 150 is provided so that a user can correct the mapped mesh in operation S830. The mesh mapping module 120 provides the user interface 150 for performing adjustment of the size of the image, adjustment of the size of the mesh, rotation of the image, rotation of the mesh, and movement of the mesh.

When the mesh mapping is completed, icons are mapped on the image in operation S840. The icons are predefined based on objects of which the sizes are generally determined, and are analyzed by the analysis module 110 using the database 140. The icons may be divided into general icons indicating general objects (e.g., human beings, cars, chairs, street trees, and the like) and length icons indicating lengths (e.g., a width of a traffic lane, a width of a railroad, a length of a street lamp, and the like). The icon may be a standard capable of measuring the size of an object based on the position of the mesh.

The user interface 150 is provided so that the user can correct the mapped icons in operation S850. The icon mapping module 130 provides the user interface 150 capable of rotating, reducing, and enlarging the icons. When the icon mapping is completed, the image is generated as a background image in operation S860. The user moves an object through a desired path in the background image, and confirms that the objects are naturally positioned in the background image. If abnormalities exist, operations S820 to S860 may be performed again.

The completed background image can be animated based on the purpose of use via, for example, an animation unit (not shown). Also, the completed background image is stored in the database 140, so that the completed background image may be utilized in a future analysis.

As described above, the image processing method and apparatus according to aspects of the present invention has several effects. For example, an animation background image can be made from a 2D image without any complicated operation process. In addition, it is easy to measure the size of an actual feature and the size of an object in an image. Further, a space that an object in an image cannot approach can be indicated.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image processing apparatus comprising:
an analysis module to analyze vanishing points of an image and icons using a database;
a mesh mapping module to map a mesh on the image based on the result of the analysis; and
an icon mapping module to map icons on the image based on the result of the analysis;
wherein the mesh includes a plurality of horizontal lines and a plurality of perspective lines, and the icons include general icons indicating objects in the image and length icons indicating lengths.

2. The image processing apparatus of claim 1, wherein the database classifies previously analyzed images by features, subjects, time, and positions.

3. The image processing apparatus of claim 1, wherein the analysis module analyzes an area where no object can be positioned in the image, and the mesh includes inhibition lines indicating the area where no object can be positioned.

4. The image processing apparatus of claim 1, wherein the mesh mapping module provides a user interface to enable a user to correct the mapped mesh.

5. The image processing apparatus of claim 4, wherein the mesh mapping module provides a user interface to perform adjustment of the image size, adjustment of the mesh size, rotation of the image, rotation of the mesh, and movement of the mesh.

6. The image processing apparatus of claim 4, wherein the mesh mapping module provides a user interface whereby, when one of the horizontal lines or the perspective lines is selected and moved, the remaining lines are moved in proportion to intervals between the lines.

7. The image processing apparatus of claim 4, wherein the mesh mapping module permits movement of grouped lines among the horizontal lines or the perspective lines, and provides a user interface whereby, when the grouped lines are moved, the remaining lines are moved in proportion to intervals among the lines.

8. The image processing apparatus of claim 4, wherein the mesh mapping module permits adjustment of intervals among grouped lines among the horizontal lines or the perspective lines, and provides a user interface whereby, when the intervals among the grouped lines are adjusted, the intervals among the remaining lines are adjusted in proportion to the intervals between the lines.

9. The image processing apparatus of claim 1, wherein the general icons include icons of human beings, cars, chairs, and street trees, and the length icons include icons of a width of a traffic lane, a width of a railroad, and a length of a street lamp.

10. The image processing apparatus of claim 1, wherein the icon mapping module provides a user interface that enables a user to correct the mapped icons.

11. An image processing method comprising:
analyzing vanishing points of an image and icons via a database;
mapping a mesh on the image based on the result of the analysis; and
mapping icons on the image based on the result of the analysis;
wherein the mesh includes a plurality of horizontal lines and a plurality of perspective lines, and the icons include general icons indicating objects in the image and length icons indicating lengths.

12. The image processing method of claim 11, wherein the database classifies previously analyzed images by features, subjects, time, and positions.

13. The image processing method of claim 11, wherein:
the analyzing of the vanishing points comprises analyzing an area where no object can be positioned in the image; and
the mesh includes inhibition lines indicating the area where no object can be positioned.

14. The image processing method of claim 11, further comprising:
providing a user interface to enable a user to correct the mapped mesh after the mapping of the mesh on the image.

15. The image processing method of claim 14, wherein the providing of the user interface comprises providing the user interface to performing adjustment of the image size, adjustment of the mesh size, rotation of the image, rotation of the mesh, and movement of the mesh.

16. The image processing method of claim 14, wherein the providing of the user interface comprises providing the user interface whereby, when one of the horizontal lines or the perspective lines is selected and moved, the remaining lines are moved in proportion to intervals between the lines.

17. The image processing method of claim 14, wherein the providing of the user interface comprises:
enabling movement of grouped lines among the horizontal lines or the perspective lines; and
providing the user interface whereby, when the grouped lines are moved, the remaining lines are moved in proportion to intervals between the lines.

18. The image processing method of claim 14, wherein the providing of the user interface comprises:
enabling adjustment of intervals among grouped lines among the horizontal lines or the perspective lines; and
providing a user interface whereby, when the intervals among the grouped lines are adjusted, the intervals among the remaining lines are adjusted in proportion to the intervals between the lines.

19. The image processing method of claim 11, wherein the general icons include icons of human beings, cars, chairs, and street trees, and the length icons include icons of a width of a traffic lane, a width of a railroad, and a length of a street lamp.

20. The image processing method of claim 11, further comprising:
providing a user interface that enables a user to correct the mapped icons after the mapping of the icons on the image.
